(19) United States
(12) Patent Application Publication
(10) Pub. No.: US 2016/0012551 A1
(43) Pub. Date: Jan. 14, 2016

(54) Apparatus and Application Server for Providing a Service to a User

(71) Applicant: MYMOJO CORPORATION, Dallas, TX (US)

(72) Inventors: John Eckerd, McKinney, TX (US); Michael Benjamin, Cedar Park, TX (US)

(73) Assignee: MYMOJO CORPORATION, Dallas, TX (US)

(21) Appl. No.: 14/600,123

(22) Filed: Jan. 20, 2015

Related U.S. Application Data
(63) Continuation-in-part of application No. 14/516,114, filed on Oct. 16, 2014.
Application No. 14/516,114 is a continuation-in-part of application No. 14/490,820, filed on Sep. 19, 2014.
Application No. 14/490,820 is a continuation-in-part of application No. 14/478,132, filed on Sep. 5, 2014.
Application No. 14/478,132 is a continuation-in-part of application No. 14/458,347, filed on Aug. 13, 2014.
Application No. 14/458,347 is a continuation-in-part of application No. 14/328,630, filed on Jul. 10, 2014.

(51) Int. Cl. G06Q 50/00; G06F 17/24; G06Q 30/06; G06F 17/22; H04L 29/08; G06Q 30/02

(52) U.S. Cl. CPC G06Q 50/01; H04L 67/02; G06Q 30/0269; G06Q 30/0246; G06Q 30/0277; G06Q 30/0601; G06Q 30/0273; G06F 17/2247; G06F 17/227; G06F 17/248

(57) ABSTRACT

An apparatus in a client computer that interacts with a website server to provide a service to a user. The apparatus receives from the website server, in any order, a plurality of Document Object Model (DOM) modules comprising Hypertext Markup Language (HTML) markup code and functional code. The apparatus separates each module into a module template comprising elements of HTML markup code that include tags to be replaced with data and a module Driver comprising an identifier (ID) tag and functional code controlling the operation of the module Driver. Execution of the Driver functional code attaches event listeners to the elements in the module template, and populates the ID tag with an internal identifier for the module, thereby creating a unique ID attribute for the Driver, which enables the Driver to operate independent of other drivers executing simultaneously on the client computer.

### CROSS-REFERENCE TO RELATED APPLICATIONS

This application is a Continuation-in-Part of U.S. patent application Ser. No. 14/516,114 filed Oct. 16, 2014, which is a Continuation-in-Part of U.S. patent application Ser. No. 14/490,820 filed Sep. 19, 2014, which is a Continuation-in-Part of U.S. patent application Ser. No. 14/478,132 filed Sep. 5, 2014, which is a Continuation-in-Part of U.S. patent application Ser. No. 14/458,347 filed Aug. 13, 2014, which is a Continuation-in-Part of U.S. patent application Ser. No. 14/328,630 filed Jul. 10, 2014, the disclosures of which are fully incorporated herein by reference.

### TECHNICAL FIELD

The present disclosure relates to an application server and an apparatus in a client computer that interact to provide a service to a user.

### BACKGROUND

A website document, which is designed to be viewed in a web browser, comprises HyperText Markup Language (HTML) markup and various assets, which are parsed by the web browser and laid out to form a visible web page. The assets include images, Cascading Style Sheet (CSS) documents, JavaScript documents, as well as any embedded media. The common practice, and industry standard, is to load the HTML of the page, and then parse other assets to alter the layout of that HTML, place images as needed, and set “listeners” (triggers) on various DOM elements in order to react to user input. The DOM is an Application Programming Interface (API) for valid HTML and well-formed XML documents. It defines the logical structure of documents and the way a document or data is accessed and manipulated. This procedure typically causes the website to be parsed as a monolithic document with JavaScript and CSS resources loaded either in the header of the DOM and/or near the bottom, so that scripts can attach listeners to, or otherwise alter, referenced DOM elements.

FIG. 1 illustrates a typical coding structure for a conventional simple website. The typical method of programming a website includes HTML mark up to set up the structure of the site. On line 7 of the code in FIG. 1, a CSS document is referenced, which causes the web browser to request the CSS document from the server. Only after the browser loads the CSS document does the browser continue to parse the rest of the HTML mark up. On line 13 of the code in FIG. 1, a JavaScript document is referenced. This reference causes the web browser to request the JavaScript document from the web server, and the code contained in the JavaScript document is compiled and run by a JavaScript engine in the browser. At that point, if the JavaScript code calls for a listener to be attached to a particular DOM element in the HTML mark up, a reference for the particular DOM element is made by the element's ID attribute, or by the element's class attribute. This requires a poll of every DOM element in the page to take place in order to find any and all elements that match the reference set by the JavaScript code. If the page is short, this polling is minimal. However, if the page is very long, and several elements are referenced by the JavaScript code, this polling becomes very expensive in terms of performance. Additionally, if care is not taken to ensure that elements have unique ID's and classes, a greedy reference by the JavaScript will cause the wrong elements to be affected, and the website functionality will become unstable and unreliable.

In the case of a conventional “static” website, when the user clicks on a link, for example a link from a home page to a sub-page of the website, the browser destroys the DOM instance for the home page and unloads it from memory. The browser then sends an HTTP request to the server requesting information from the server for the sub-page. The browser then creates a new DOM instance for the sub-page. Thereafter, this process of downloading resources, creating a new DOM instance, and then destroying the DOM instance and starting over is repeated for each new page requested by the user.

FIG. 2 is a message flow diagram illustrating the flow of messages between a user 10, a client browser 11, and a website server 12 in a method of operating a conventional static website. At step 13, the user types in a web address directing the browser to go to the website, somesite.com/home. At step 14, the browser requests information from the server for the home page of somesite.com by sending an HTTP request to the server. At step 15, the server processes the request and returns to the browser, a string containing resources such as full HTML, CSS documents, JavaScript code, and all content data associated with the home page. At step 16, the browser interprets the HTML code and creates a new DOM instance. In optional steps 17 and 18, the browser may request and receive from the server, cacheable resources that have not yet been downloaded.

At step 19, the browser interprets and executes the JavaScript code, and displays the somesite.com home page to the user. At step 20, the user browses the home page, and at step 21, attempts to view content that was not included in the original content data received from the server. For example, the user may click on a link to a sub-page of the somesite.com website. In response, the browser destroys the DOM instance for the home page and unloads it from memory at step 22. At step 23, the browser then sends an HTTP request to the server requesting information from the server for the sub-page of somesite.com. The process then repeats, with the browser creating a new DOM instance for the sub-page. Thereafter, this process of downloading resources, creating a new DOM instance, and then destroying the DOM instance and starting over is repeated for each new page requested by the user.

In order to break the monolithic nature of a website and cause the content to be delivered in a modular fashion, a templating system is often used. In such a system, reusable HTML markup code is used as a template, and a data source is used to populate various portions of the template, before being rendered as needed within the webpage. There are basically two types of templating systems—those that run on the server side, and those that run on the client side. In both instances, a data source is used to populate various fields within an HTML template, and the resulting HTML code is returned to the web browser for display.

FIG. 3A illustrates a typical coding structure for producing a simple server-side template. Server-side templates take data from a data source, populate the template, and then piece together the rendered results to create a single web page, before sending it to the browser for display. Server-side templates employ a templating engine in the server-side code to populate templates that are coded in HTML and either a proprietary templating language or the corresponding server-side code.

FIG. 3B illustrates a typical coding structure for replacing the tags in the server-side template of FIG. 3A with data. Server-side code such as PHP: Hypertext Preprocessor (PHP) takes data from a data source and makes a call to the templating engine to replace the tags in the template with the data. Thus, in the above example, a typical templating engine is invoked, provided with variables from a data source, and then rendered to return the HTML to the client browser.

Server-side templating engines separate presentation development from data modeling and business logic development, and provide a code base that is easier to maintain and change as needed. Server-side templating engines also allow for HTML template code to be reused, which reduces the amount of code that has to be written, which in turn reduces the chances for bugs or breaking functionality when changes are made. However, server-side templating engines return full HTML documents to the client, and much of the HTML being transferred in the response from the server is likely to be duplicated blocks of code with different values in the fields. For example, the following HTML is repeated three times with different values:

<div>Bill</div>

<div>Bob</div>

<div>Joe</div>

The HTML for each element is a simple <div></div> tag group, and it is repeated with different first names inserted. However, because the HTML was rendered in the server-side code, the entire string of HTML code is sent to the client. In this small example, the amount of code is negligible. However, on large websites with extremely large numbers of repeating objects, this is very inefficient and requires much more bandwidth than should be necessary.

Client-side templates send a copy of the template to the client's browser, along with structured data to serve as a data source, and the template is populated with JavaScript in the browser. This method greatly reduces bandwidth usage between the client and server on sites that have a large amount of content with duplicated formatting.

Client-side templates are typically managed by templating engines that are written in JavaScript. Therefore, they run within the JavaScript virtual machine built into the web browser. In this scenario, only one copy of the template is sent in the response from the web server, along with a string of structured data to be used for populating the template. The templating engine in the web browser is then called in JavaScript code within the document to parse the data source, replace the tags appropriately within the template, and then render the template as many times as needed within the browser.

FIG. 4 illustrates a typical coding structure for producing a client-side template using the same example as shown above, but implemented in client-side templating. While this example comprises more lines of code than the server-side example, it does not grow in size as the number of elements in the data source grows. In other words, if the “names” variable contained 100 names, the only change would be that one line would be longer, and no other lines of code are needed. Additionally, if the data source was referencing a function (as shown in the commented code line), the amount of data items could be extremely large without additional code being written.

Most importantly, however, is the fact that this is the total amount of code that would be required to be sent in the web server response, and the data string could be sent in separate calls to the server as needed.

Thus, using client-side templates provides a large decrease in bandwidth required for a large website containing several blocks of repeated markup sections. Additionally, since the HTML template is already loaded into the browser, additional calls to the server for more data can be made asynchronously to populate a site with fresh content, or additional content, in response to time passing or user interaction with the page.

Client-side templating engines are typically written in JavaScript and are available with open source as well as commercial licensing. While they produce the advantages stated above, none are as robust as their server-side counterparts with regard to nesting, embedded logic, and the capability to pass complex data structures.

FIG. 5 illustrates a simplified example of the use of client-side templates in a conventional website. This example uses Handlebars.js, which is a popular templating engine. Those skilled in the art will readily recognize this coding structure. Although such a templating system assists with modularity, as well as separating presentation design from the data source, on a very large site with a large number of modular sections, collisions in class definitions and the increased polling required to attach listeners to specific DOM elements negatively impact scaling, performance, and reliability.

FIG. 6 illustrates a typical coding structure for the use of a common client-side templating engine, which allows a reusable template to be populated from a data source. In this example, an HTML template containing replaceable tags for “title” and “body” is included in a script block. The templating engine then compiles the template. Then, a data source is defined, which may be static data or a web service that returns the data in a usable format. The example includes hard-coded static data for demonstration purposes only. Those tags in the compiled template are replaced by data contained in the data source object, based on the names for each of the object elements. For example, {{title}} in the template may be replaced by “My New Post”, when that is the value of the “title” element in the data source object. HTML is rendered from the compiled template with replaced values and then the “div” element with the ID attribute of “content_div” is populated with the resulting HTML.

This method of programming allows for reuse of presentation mark up code (HTML), and separates the data from the presentation for maintainability and readability of the code. However, when scaled to larger sites, performance degrades quickly because the compilation of templates and the bloat in the third-party templating engine library is expensive in terms of processing resources. Additionally, the excess polling problem mentioned previously is not addressed. Once the template is compiled, values are replaced, and HTML is generated, the JavaScript must search the DOM for the correct element to populate with the results. Again, this causes increasingly poor performance as the size of the site grows and the number of DOM elements increases. The possibility of class collisions also still exists.

When building an interactive web application, client-side code written in JavaScript is typically used to attach event listeners onto DOM elements, run specific callback functions when those events are triggered, and manipulate the DOM elements as necessary to provide feedback for user interaction. In all but the smallest and simplest applications, it is often necessary to include more than one script tag in the DOM, which includes the JavaScript code to manage the application. This is especially the case when creating modular applications in which each module contains a script block to control the module to which the script block is attached.

FIG. 7A illustrates a typical coding structure for managing DOM elements defined just prior to a script block. The code contains two sections of code, which includes HTML markup and two JavaScript blocks. In this example, the code in the two script blocks will run sequentially as the browser loads them into the DOM. This method of development is typical and does not pose problems in simple web applications with very little user interaction required. However, as web applications have become more complex, a need to reference which script block's code is currently running has developed. One example of this is when scripts are being loaded dynamically in repeated modules on a single page, and each script block is required to act on DOM elements only within the module to which the script block is attached.

FIG. 7B illustrates a typical coding structure for loading scripts dynamically in repeated modules on a single page. In this example, the first module will load into the DOM and the code in the module's script block will run, inserting the word “Contents” into the first <div> element with the class name of “container”, as expected. However, when the page continues loading, the second module will load into the DOM and the code in the second script tag will run. It will insert the word “Contents2” into all elements in the DOM that have the class of “container.” This will not only insert the content into the div tag contained as part of the second module, it will also replace the contents in the div tag which is part of the first module, because it also has the class name of “container.” Additionally, running the third module's code will result in the content of all three div elements being “Content3.”

The problem shown in this example can be avoided by having a unique ID for each div tag and writing the JavaScript to reference the tag by the ID attribute. However, this limits code reuse and many other advantages gained by using a modular, template-driven website composition.

FIG. 8 illustrates a coding structure for an alternative way to load scripts dynamically in repeated modules on a single page. In this example, the problem is solved by making the scripts aware of themselves, and referencing only the DOM elements relative to each script. However, although this method solves the problem when loading modules sequentially, it does not work when modules are loaded dynamically or asynchronously. Also, the currentScript property is likely to return a reference to the incorrect DOM element should another script be running asynchronously elsewhere in the page. The currentScript property is also not supported in many older browsers.

### SUMMARY

The typical method of developing a website does not lend itself to modularity, and performance is greatly reduced as the site scales in size and traffic. The trend is for websites to use a variety of disparate data sources to build content in a modular fashion, and then to compile the modules together to form a webpage. As the number of different types of modules increases, or even the number of modules of a single type increases, class collisions and excess DOM polling create instability and performance degradation in the browser, as well as an increased load on the server. Additionally, because the modules are loaded synchronously as the page is rendered, the poor performance of a single module negatively affects all other modules below it in the DOM structure.

It would be advantageous to have a method of assembling the contents of a website that overcomes the deficiencies of traditional website design methodologies. The disclosed solution provides the bandwidth savings and performance enhancements of the typical client-side solution, with the robust feature set that server-side engines typically employ. This is achieved, in part, by encapsulating each module, and programming the software to sandbox the CSS and JavaScript for each module to avoid collisions, while at the same time, allowing modules to interact on a specified level as needed during user interaction.

The present disclosure provides a method of software development that creates a modular website, in which each module contains an HTML template, as well as a JavaScript block referred to as a “Driver”, which, when initialized, provides the data source and any DOM manipulation instructions necessary to make the template elements behave as desired. The combination of these elements creates a website that is modular and capable of using disparate data sources while eliminating the performance degradation and class collisions associated with other methods.

The method includes the development of a client-side templating engine, which uses simple string replacement to populate elements from a data source. The templating engine does not require compilation, and does not contain code for logical operators or other unnecessary functionality found in other commercial and open source offerings. The engine performs all of the functionality required to return HTML from a call to a single function. Calling this function from JavaScript code, and sending the correct information in the call, allows the templating engine to retrieve the proper template as well as retrieve and parse the data source. The templating engine retrieves all required information from a server-side controller when called correctly, thus eliminating the need to specify a data source for the module. Additionally, the module templates may be compressed and cached in the client's browser as JavaScript Object Notation (JSON) files so that repeated calls for the same template does not require a request being sent to the web server. This greatly improves bandwidth utilization, performance, and scalability of the web application.

The method also utilizes class namespacing in the CSS portions of each module. This eliminates class collisions and speeds up DOM polling when attaching listeners to DOM elements, or when manipulating DOM elements.

Each module includes a “Driver”, written in JavaScript. The Driver receives instructions from the calling script and performs a number of functions. The Driver retrieves data from a defined data source for the module, populates and renders the template portion of the module, attaches listeners to the DOM elements of the template, and manipulates the DOM elements of the template as needed in order to allow user interaction with the module.

The Driver code for each module may be initialized and run asynchronously, rather than having one module waiting for another. This functionality improves the user experience and ensures the performance of each module does not affect the performance of other modules. The client web browser dynamically loads in any order, a plurality of modules comprising Hypertext Markup Language (HTML) markup for a webpage when one or more HTML scripts are running asynchronously elsewhere on the webpage. The web browser is implemented in a computer having a processor and a memory, and the web browser is in communication with a website server via a network connecting the computer and the web server. The web browser receives from the web server, information for creating a DOM from the plurality of modules. The processor performs the following steps for each module: separating the module into two functional parts: (1) a module template comprising HTML markup that includes tags to be replaced with data; and (2) a module Driver comprising an identifier tag and functional code controlling the operation of the module Driver. The functional code controlling the operation of the module Driver causes the module Driver to populate the identifier tag with an internal identifier for the module, thereby creating a unique ID attribute for the Driver, which enables the Driver to operate independent of other drivers that control other modules.

When the module Driver includes a driver variable, the client web browser may also set the driver variable to reference the module Driver, thereby loading the functional code into memory and removing the module Driver from the DOM.

When the module Driver includes a display variable, the client web browser may also set the display variable to reference in the module template, a DOM element that can be found relative to the module Driver, thereby sandboxing all actions by the module Driver into the referenced DOM element in the template. This DOM element is preferably the DOM element immediately prior to the module Driver. Referencing the DOM element in the template prevents collisions with the scripts running asynchronously elsewhere on the webpage, and eliminates polling for matching DOM elements.

One embodiment of the present disclosure is directed toward an apparatus in a client computer that interacts with a user and with a remote application server to provide a service to the user. The apparatus includes a non-transitory memory that stores a client application program; an execution unit comprising a processor coupled to the memory, the processor executing the client application program; and a communication interface that communicates between the client computer and the remote application server via a network. The communication interface receives from the remote application server, in any order, a plurality of modules comprising Hypertext Markup Language (HTML) markup code and functional code. The execution unit separates each module into two functional parts during execution, the functional parts including a module template comprising elements of HTML markup code that include tags to be replaced with data; and a module Driver comprising an identifier (ID) tag and functional code controlling the operation of the module Driver. When the processor executes the functional code controlling the operation of the module Driver, the module Driver is caused to attach event listeners to the elements in the module template, and to populate the ID tag with an internal identifier for the module, thereby creating a unique ID attribute for the Driver, which enables the Driver to operate independent of other drivers that control other modules executing simultaneously on the client computer.

The application program may be a client web browser, the remote application server may be a website server, and the modules may be Document Object Model (DOM) modules for operating a webpage. The method allows the loading of DOM modules either sequentially or dynamically in any order, even when another script is running asynchronously elsewhere on the page. The method also allows nested modules to be loaded to create parent-child relationships between modules, while maintaining the correct context for the running code within each individual module.

In one embodiment, execution of the DOM modules causes a display interface to display in at least one block of graphics or descriptive text, a description of a discounted product or service from a merchant; causes the module Driver to detect activation of an associated link by the user; and in response, causes the communication interface to send an indication to the website server that the user desires to purchase an option to purchase the product or service from the merchant at a discounted price for a defined period of time.

Another embodiment is directed toward an application server that interacts with a remote client computer to provide a service to a user. The application server includes a non-transitory memory that stores an application program; an execution unit comprising a processor coupled to the memory, the processor executing the application program; and a communication interface that communicates between the application server and the remote client computer via a network. The communication interface receives from the client computer, a request from the user to use the service, and in response, the application server sends to the remote client computer, in any order, a plurality of modules comprising HTML markup code and functional code that, when executed by the client computer, provides the service to the user and enables each module to be executed independent of others of the plurality of modules that are executing simultaneously on the client computer.

The application server may be a website server, the client computer may execute a client web browser, and the modules may be DOM modules for operating a webpage. The website server may execute the application program to enable the user to purchase an option to purchase a product or service from a merchant at a discounted price for a defined period of time.

Another embodiment is directed toward a computer-implemented method in an application server for providing a service to a user. The application server interacts with a remote client computer via a network to provide the service to the user. The method includes the steps of storing in a non-transitory memory coupled to a processor, an application program for providing the service to the user; receiving via a communication interface from the remote client computer, a request from the user to use the service; and in response to receiving the request, executing the application program by the processor. Executing the application program includes sending to the remote client computer, in any order, a plurality of modules comprising HTML markup code and functional code that, when executed by the client computer, provides the service to the user and enables each module to be executed independent of others of the plurality of modules that are executing simultaneously.

The application server may be a website server and the remote client computer may execute a client web browser, and the step of sending the plurality of modules to the remote client computer may include sending to the remote client computer, in any order, a plurality of DOM modules for operating a webpage. In this embodiment, the website server may execute the application program to enable the user to purchase an option to purchase a product or service from a merchant at a discounted price for a defined period of time.

The method may also include connecting the website server to a social media network; displaying an announcement on the social media network indicating that a discount for the product or service from the merchant is available on the website; when the remote client computer requests to connect to the website server, sending the DOM modules from the website server to the remote client computer; and receiving an indication from the remote client computer that the user selected to purchase the option to purchase the product or service from the merchant at the discounted price for the defined period of time.

In one embodiment, the announcement on the social media network indicates that the discount for the product or service is promoted by a celebrity, and the method may also include, after receiving the indication from the remote client computer that the user selected to purchase the option, sending an indication of the purchase from the application server to a financial accounting system where a credit is applied to an account of the celebrity.

In a further embodiment, the method may also include receiving an indication from the remote client computer that the user selected to purchase the option to purchase the product or service from the merchant at the discounted price for the defined period of time; and providing information to the user enabling the user to exercise the option to purchase the product or service directly from the merchant without further involvement by the website server and without any commission payable by the merchant.

In a further embodiment, the method may also include providing the merchant with access to an advertisement building program; and executing the advertisement building program by the processor, wherein executing the advertisement building program includes providing the merchant with online tools to design and create for display on the website, an advertisement for the discounted product or service.

In a further embodiment, the method may also include providing the merchant with access to a deal management program; and executing the deal management program by the processor, wherein executing the deal management program includes providing the merchant with information and interactive capabilities to manage and track the effectiveness of options posted on the website.

Further features and benefits of embodiments of the disclosure will become apparent from the detailed description below.

### BRIEF DESCRIPTION OF THE DRAWINGS

In the following section, the invention will be described with reference to exemplary embodiments illustrated in the figures, in which:

FIG. 1 (Prior Art) illustrates a typical conventional coding structure for a simple website;

FIG. 2 (Prior Art) is a message flow diagram illustrating the flow of messages between a user, a client browser, and a website server in a method of operating a conventional static website;

FIG. 3A (Prior Art) illustrates a typical coding structure for producing a simple server-side template;

FIG. 3B (Prior Art) illustrates a typical coding structure for replacing the tags in the server-side template of FIG. 3A with data;

FIG. 4 (Prior Art) illustrates a typical coding structure for producing a client-side template;

FIG. 5 (Prior Art) illustrates a typical conventional coding structure for the use of client-side templates in a conventional website;

FIG. 6 (Prior Art) illustrates a typical conventional coding structure for the use of a client-side templating engine;

FIG. 7A (Prior Art) illustrates a typical coding structure for managing DOM elements defined just prior to a script block;

FIG. 7B (Prior Art) illustrates a typical coding structure for loading scripts dynamically in repeated modules on a single page;

FIG. 8 (Prior Art) illustrates a coding structure for an alternative way to load scripts dynamically in repeated modules on a single page;

FIG. 9 illustrates the skeleton code for beginning to program a module in accordance with the present disclosure;

FIG. 10 illustrates the coding structure for use of a template driver system to create a modular section of a larger HTML document;

FIG. 11 illustrates the coding structure for the “post” module called in lines 14 and 17 of the code in FIG. 10;

FIG. 12 illustrates the coding structure for the “ad” module called in line 20 of the code in FIG. 10;

FIG. 13 illustrates the coding structure for an example of nested modules;

FIG. 14 illustrates the coding structure for the example “album” module of FIG. 13;

FIG. 15 illustrates the coding structure for a procedure for calling the code to create a “photo” module;

FIG. 16A (Prior Art) illustrates objects representing a conventional simple data structure in a single level;

FIG. 16B illustrates objects representing a slightly more complex data structure having two levels;

FIG. 16C illustrates objects representing a complex data structure supported by the Driver system of the present disclosure;

FIG. 17 is a simplified block diagram of the client-side web browser of the present disclosure;

FIG. 18 is a simplified block diagram of the client-side web browser of the present disclosure;

FIG. 19 is a flow chart illustrating a first exemplary embodiment of a method according to the present disclosure;

FIG. 20 is a flow chart illustrating a second exemplary embodiment of a method according to the present disclosure;

FIG. 21 is a flow chart illustrating a third exemplary embodiment of a method according to the present disclosure;

FIG. 22 is a flow chart illustrating a fourth exemplary embodiment of a method according to the present disclosure;

FIG. 23 illustrates the coding structure for an exemplary DOM module having client-side functional code in both a module Driver and a module template;

FIG. 24 illustrates a coding structure resulting from executing the functional code of FIG. 23;

FIG. 25 illustrates a coding structure for each item resulting from executing the functional code of FIG. 23;

FIG. 26 is a flow chart illustrating a fifth exemplary embodiment of a method according to the present disclosure;

FIG. 27 is a flow chart illustrating additional details of the module execution of FIG. 26;

FIG. 28 is a flow chart illustrating a sixth exemplary embodiment of a method according to the present disclosure;

FIG. 29 is a simplified block diagram of an apparatus in a client computer for providing a service to a user in accordance with the present disclosure;

FIG. 30 is a simplified block diagram of a website server for providing a service to a user in accordance with the present disclosure; and

FIG. 31 is a flow chart illustrating a seventh exemplary embodiment of a method according to the present disclosure.

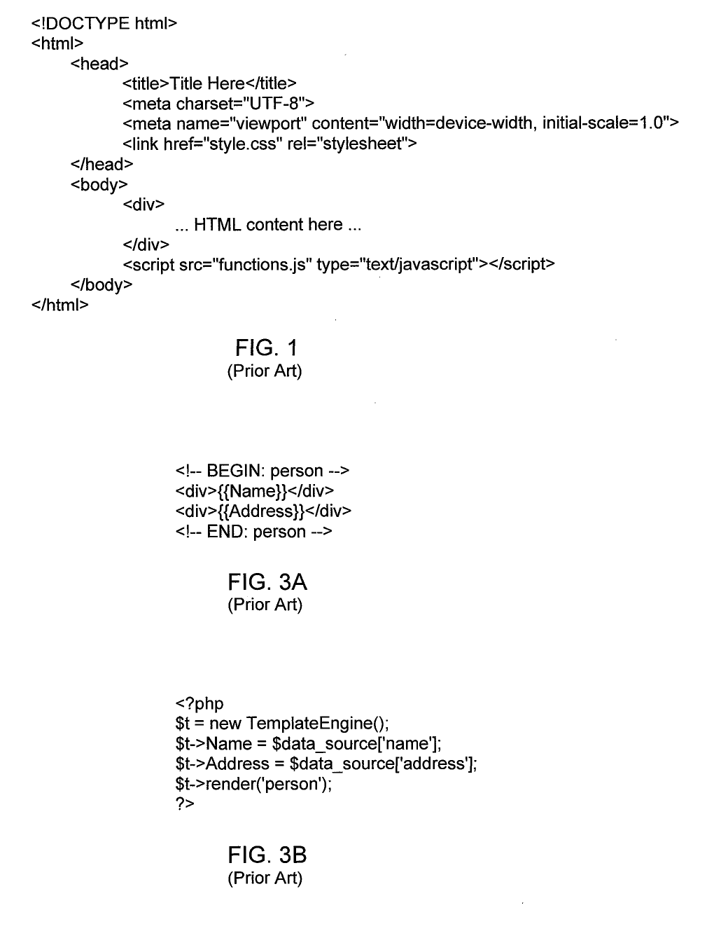

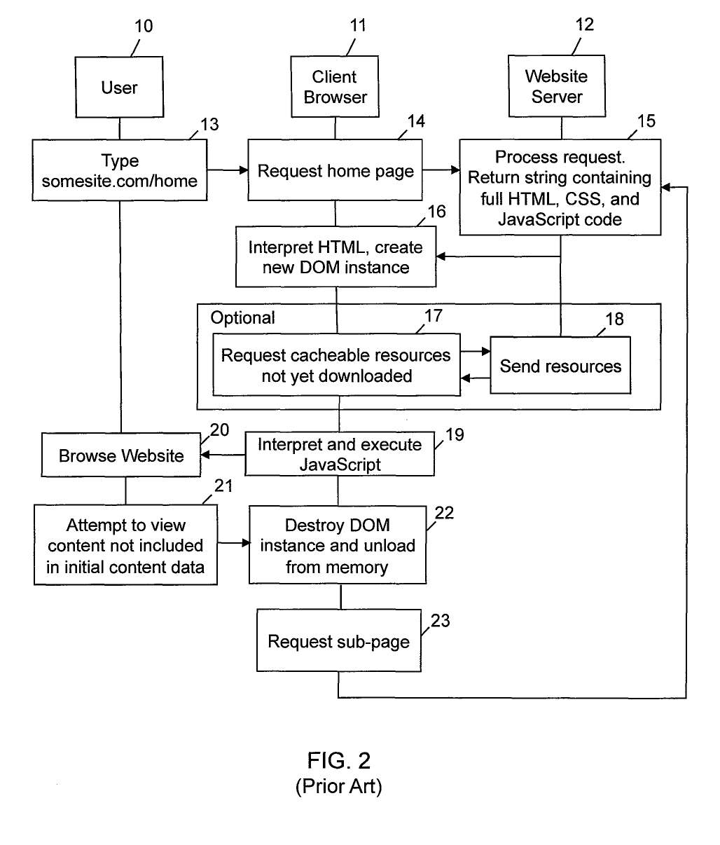

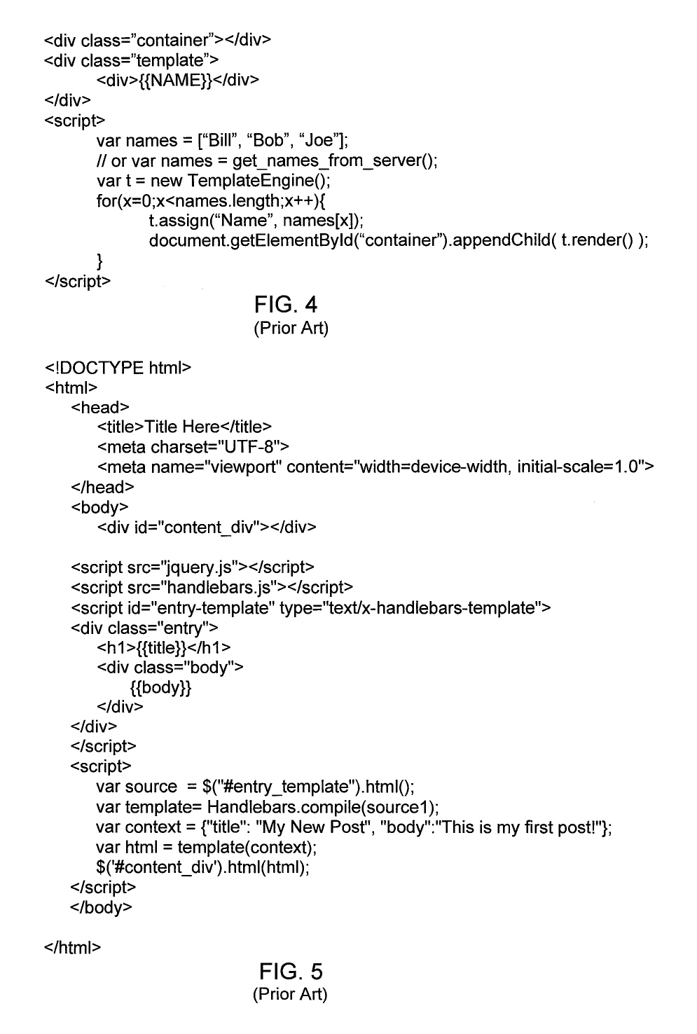

### DETAILED DESCRIPTION

The present disclosure will now be described more fully hereinafter with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements. Additionally, it should be understood that the invention can be implemented in hardware or a combination of software stored on a non-transitory memory and executed by a general purpose computer or microprocessor. Various “servers” and “systems” disclosed herein are understood by those skilled in the art to include processors, non-transitory memories, and software comprising computer program instructions to be executed by the processors thereby causing the servers and systems to perform the stated functions.

FIG. 9 illustrates the skeleton code for beginning to program a module in one exemplary embodiment of the present disclosure. This embodiment illustrates that the module includes a module Driver written in JavaScript. The Driver code for each module may be initialized and run asynchronously, rather than having one module waiting for another. This functionality improves the user experience and ensures the performance of each module does not affect the performance of other modules. The module Driver may include an identifier tag, functional code controlling the operation of the module Driver, a driver variable, and a display variable. The functional code may populate the identifier tag with an internal identifier for the module, thereby creating a unique ID attribute for the Driver, which enables the Driver to operate independent of other drivers that control other modules. The functional code may also set the driver variable to reference the module Driver, thereby loading the functional code into memory and removing the Driver from the DOM. This function further reduces the size of the DOM and thereby further reduces polling and querying requirements of other client-side code. The functional code may also set the display variable to reference in the module template, a DOM element immediately prior to the module Driver, thereby sandboxing all actions by the module Driver into the referenced DOM element in the template, preventing collisions with the scripts running asynchronously elsewhere on the webpage, and eliminating polling for matching DOM elements.

Once initialized, the Driver receives instructions from the calling script and may retrieve data from a defined data source for the module, populate and render the template portion of the module, attach listeners (triggers) to the DOM elements of the template, and manipulate the DOM elements of the template as needed in order to enable user interaction with the module.

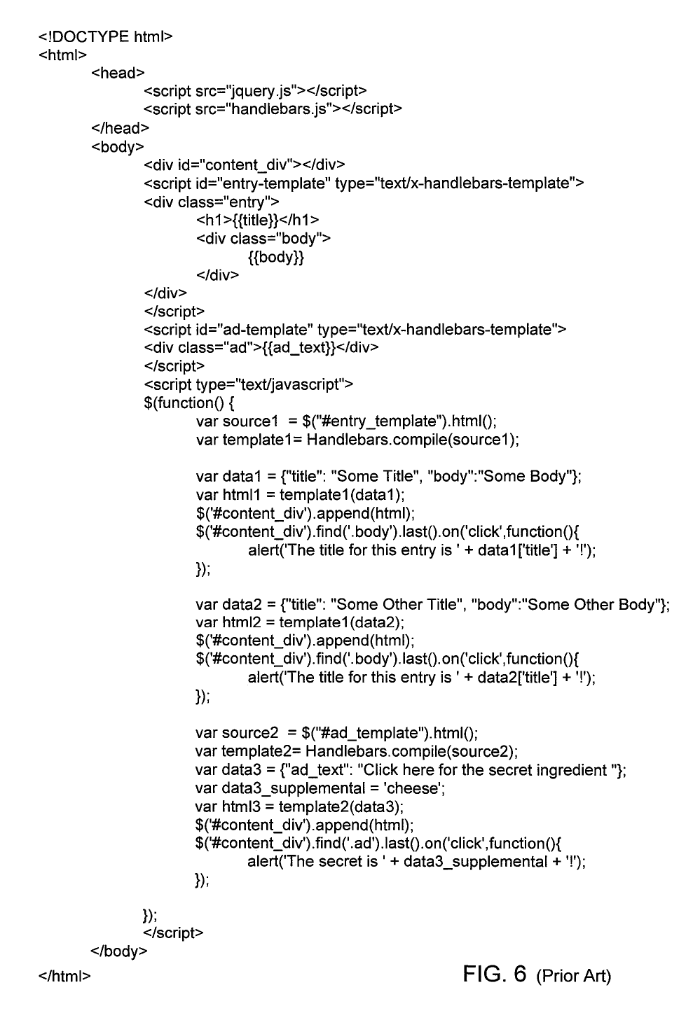

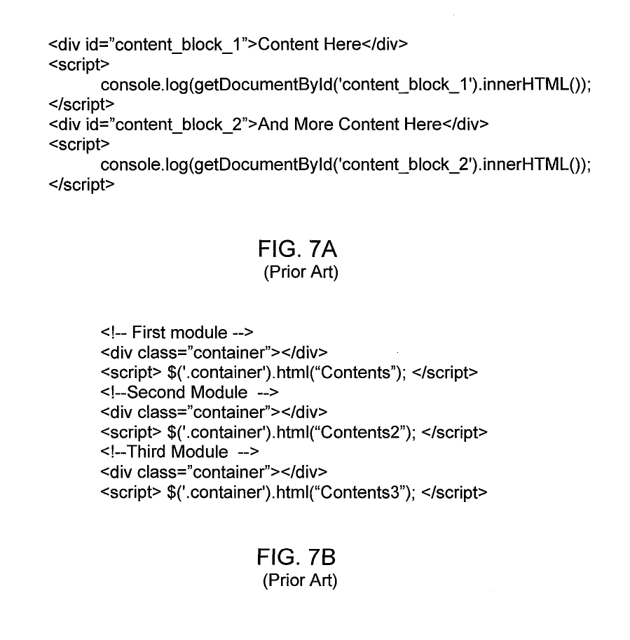

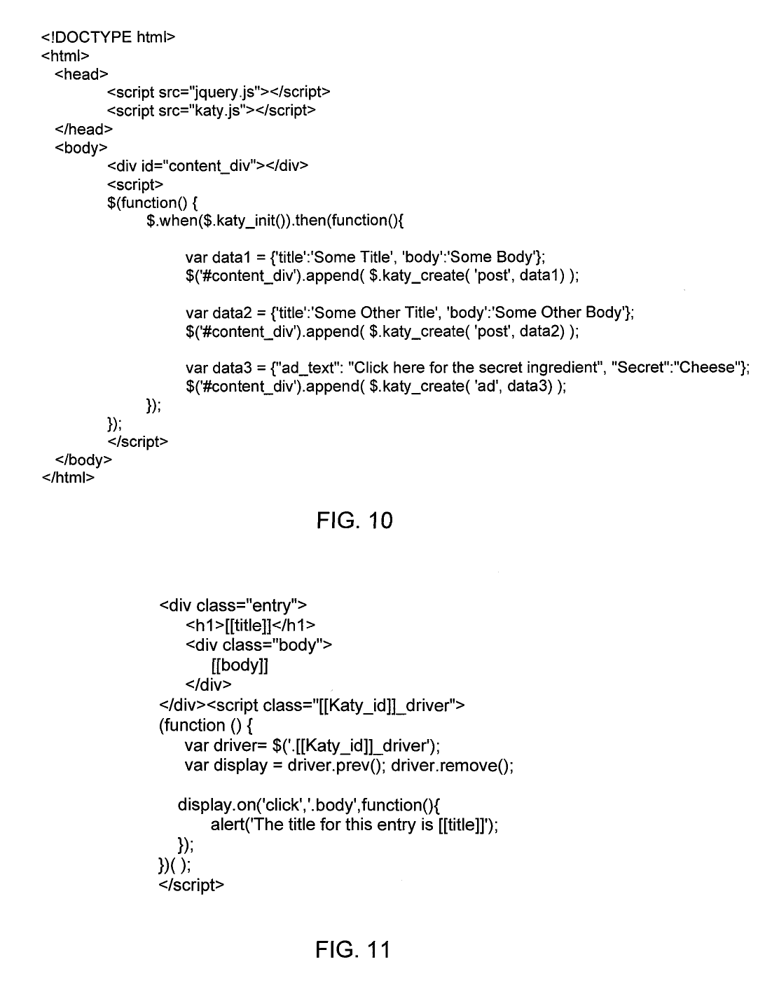

FIG. 10 illustrates the coding structure for use of a template driver system to create a modular section of a larger HTML document. This process produces templates similar to the method of FIG. 6, but utilizes a modular architecture and employs a JavaScript Driver for each module. In this example, the <div> tag with the ID of “content_div” becomes a container for the content that will be generated. With the templating engine given the nickname “Katy Library”, functions beginning with “katy_” are calling methods within that templating engine library. The first function in line 11 of the code, katy_init( ), reports back when the engine is ready to begin processing templates and data. Then, within that conditional block, three modules are called using the katy_create( ) function. The katy_create( ) function takes two arguments: the type of module to create (such as “post” or “ad”) and the data to pass to the module (such as “data1”, “data2”, or “data3”). This information is hard coded in the example, but it may also be from a remote data source, which returns the required data in a JSON format.

FIG. 11 illustrates the coding structure for the “post” module called in lines 14 and 17 of the code in FIG. 10. The top five lines of the module provide the HTML template portion, which contains tags to be replaced with data. In this example, there are two tags—[[title]] and [[body]]. The templating engine utilizes string replacement to replace these tags with the values passed to it in the data source variable—the second argument passed to the katy_create( ) function as noted above. Below the HTML markup code, or template, is a JavaScript block containing the Driver for this individual module. It also has a tag, [[Katy_id]], in line 6 of the code, which is populated with the internal ID of the module, thereby creating a unique ID attribute for this block of JavaScript, or Driver. This enables the Driver to run independently from other Drivers being loaded in an asynchronous manner. Also, by setting the “display” variable in the JavaScript to reference the DOM element in the template portion just prior to the Driver (i.e., ‘body’), all action by the JavaScript can be sandboxed (i.e. isolated) into that DOM element, in effect, and collisions are prevented. This also eliminates unnecessary polling for matching DOM elements by the JavaScript and greatly improves performance.

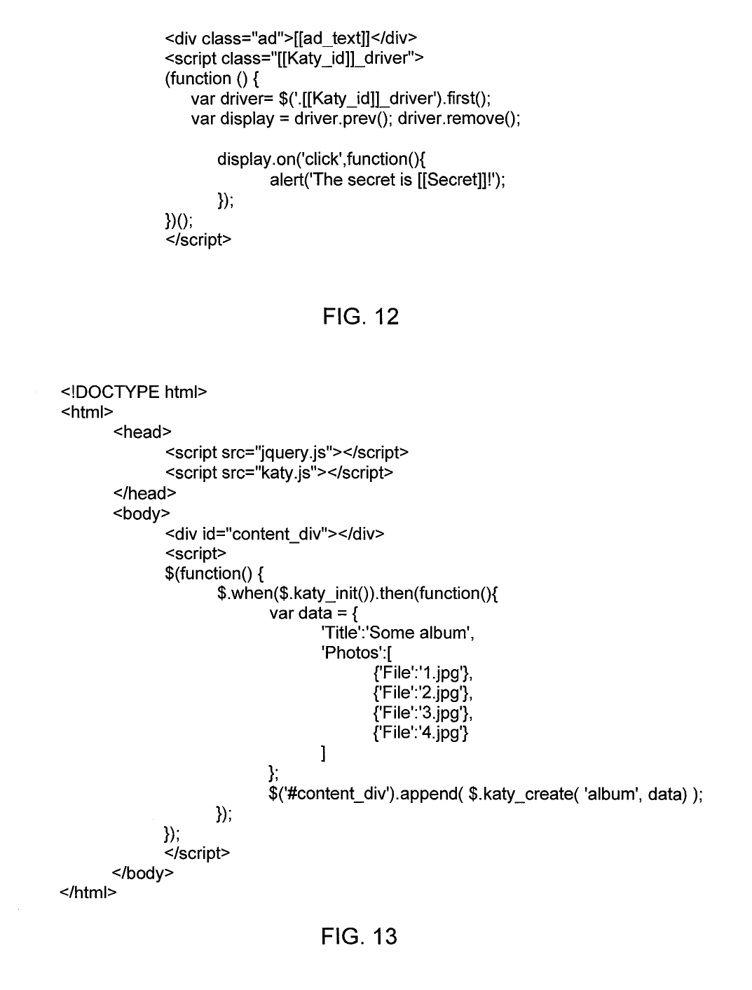

FIG. 12 illustrates the coding structure for the “ad” module called in line 20 of the code in FIG. 10. As described above, the tag [[ad_text]] is replaced by the value of data referencing the same name. Also, the [[Katy_id]] tag is populated with the internal ID of the module once again, so that the Driver in this module can run its code asynchronously without affecting or waiting on the Drivers of other modules. Again, all actions by the Driver code can be sandboxed by referencing the elements within the DOM node, as set in the “display” variable.

FIG. 13 illustrates the coding structure for an example of nesting modules. The nesting feature enables modules to be made from a collection of other, smaller modules. In this way, code may be broken into smaller and more manageable pieces to improve maintenance and development quality. An example is a photo “album” module, which comprises several “photo” modules. In the illustrated example, the data source contains an album object, and an array of photo objects. A single call is made to the Katy Library to create the album module using the katy_create( ) method. In line 21 of the code shown in FIG. 13, the katy_create( ) method is invoked, and a JavaScript object is passed in the second parameter comprising the data needed to build the album. There is an album title, and a collection of photos to be included in the album. Katy then retrieves the album template and replaces the title tag in the album module template with the album title in the data source. Then, the JavaScript module Driver within the template iterates through the photo elements, calling the katy_create( ) method for each one and creating a photo module. As the photo modules are created, they are appended to the template of the album module, and when complete, the entire block of HTML is returned to represent the full album of photos.

In this manner, the complex data object that was originally passed to the Katy Library to create the album is cascaded down as needed to build as many nested layers as necessary. The nesting levels are unlimited by the library and multiple level complex data objects can be cascaded down through any number of layers to build very complex, but modular website content.

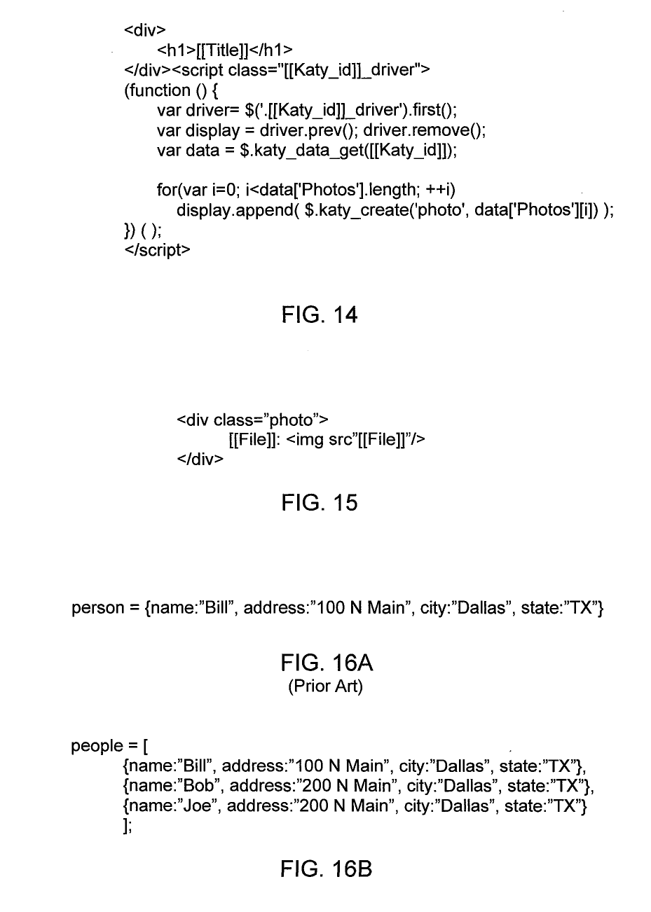

FIG. 14 illustrates the coding structure for the example “album” module of FIG. 13. In this example, the [[Title]] tag is replaced with the album title value passed in the data source variable. The “Photos” array is then iterated and the value of each array element is passed to the katy_create( ) method, which returns a photo module and appends that module into the album module. Once the iteration is complete, the entire album module is returned to the original katy_create( ) method shown in FIG. 9.

FIG. 15 illustrates the coding structure for a procedure for calling the code to create a “photo” module. This module is very simple, and contains only an HTML template, as no user interaction is required. The [[File]] tag is replaced by the value passed in the data object sent to the katy_create( ) method in FIG. 14, and the HTML is returned to that function. If user interaction or DOM manipulation is needed in this module, a JavaScript Driver is appended after the containing <div> element as shown in the other module examples described above.

Looking in further detail at the client-side templating engine of the present disclosure, the following features become evident (with the engine given the nickname “Katy Library” all methods are prefixed with “katy_”):

The ability to pass complex data structures. Data streams are typically passed as JavaScript object instances or JavaScript array instances, but are usually limited to a single level and with all elements of the object having string values.

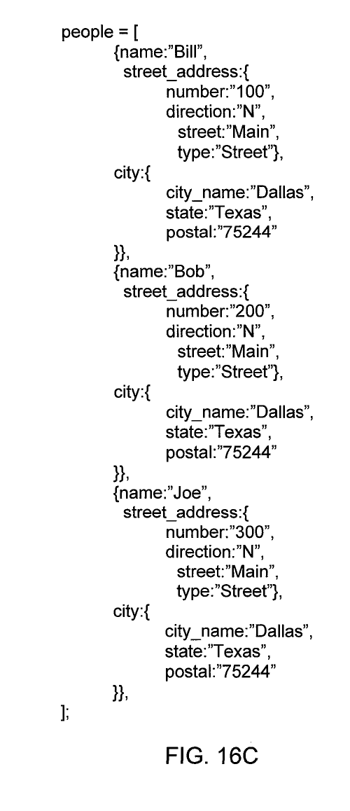

FIG. 16A illustrates objects representing a conventional simple data structure in a single level.

FIG. 16B illustrates objects representing a slightly more complex data structure having two levels.

FIG. 16C illustrates objects representing a complex data structure supported by the Driver system of the present disclosure. Such complex data structures can develop very quickly when building modular website components with nesting capabilities.

Supporting this type of complex data structures enables other robust features of the Katy Library, specifically nesting (as described above) and embedded logic and other client-side code. Embedded logic and other client-side code provide additional capabilities. For example, the template may include a mixture of HTML and JavaScript code, and the data source can be used to populate fields in any portion of that template. The JavaScript can then run complex logical calculations on the data and display different portions of the template, or display portions of the template differently, depending on the results of those calculations. Additionally, JavaScript code can be used similarly to manage the DOM elements of the HTML template in order to attach event listeners to those objects, or manipulate the objects based on user interaction or other events. Such code may be implemented in module Drivers, which often accompany the template code.

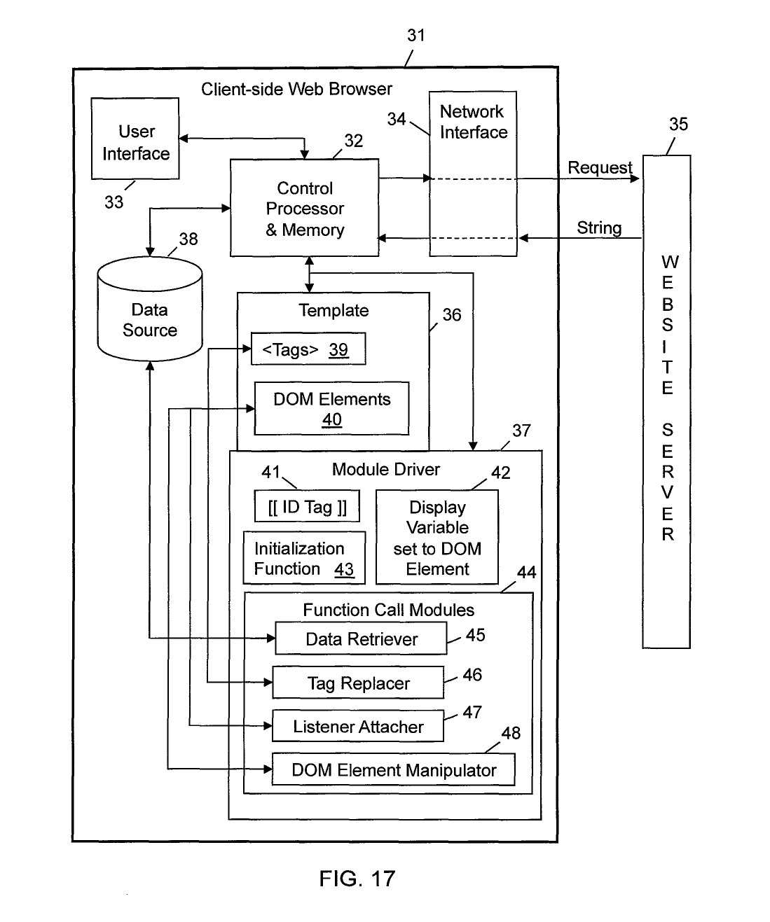

FIG. 17 is a simplified block diagram of the client-side web browser 31 of the present disclosure. Operation of the browser may be controlled, for example, by a control processor 32 and associated memory for storing computer program instructions. A user interface 33 enables communication to and from the user, and a network interface 34 enables communication to and from a website server 35. The browser may request information for a website from the server by sending, for example, an HTTP request to the server. In response, the browser receives an information string containing resources such as a minimal amount of HTML, CSS, and JavaScript code, and compressed initial content data associated with DOM modules for the website home page encoded in a cacheable JSON file. For a given module, the information received from the server includes HTML code for a template 36 and JavaScript code for a module Driver 37. The content may be stored in cache or in a data source 38.

The template 36 may include various tags 39 such as the <div> tag with the ID of “content_div”, which becomes a container for the content that will be generated. The template may also include various DOM elements 40 that provide the functionality of the module, once populated by the Driver 37. The Driver may include an ID tag 41, a Display variable 42, which is set to a DOM element 40 in the template, an initialization function 43 and call function modules 44. The call function modules may include a data retriever module 45, a tag replacer 46, a listener attacher 47, and a DOM element manipulator 48.

Once initialized, the Driver 37 receives instructions from the calling script and may retrieve data from a defined data source for the module, populate and render the template portion of the module, attach event listeners (triggers) to the DOM elements of the template, and manipulate the DOM elements of the template as needed in order to enable user interaction with the module.

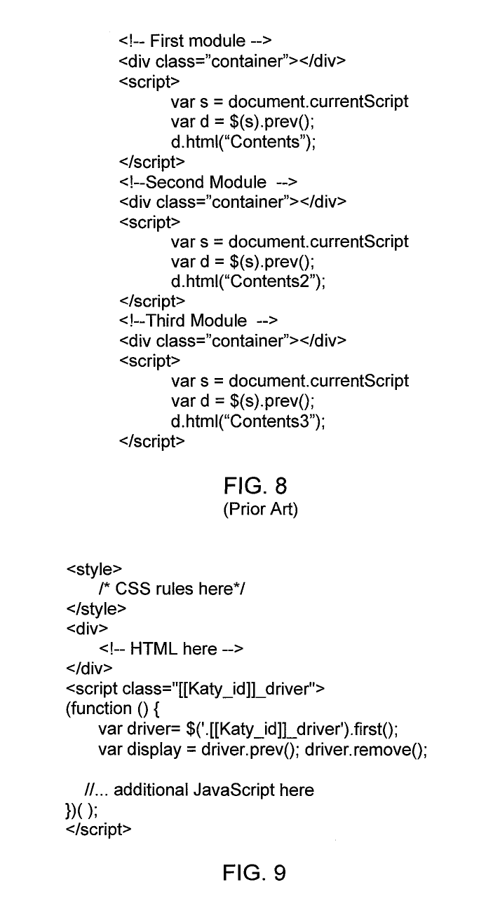

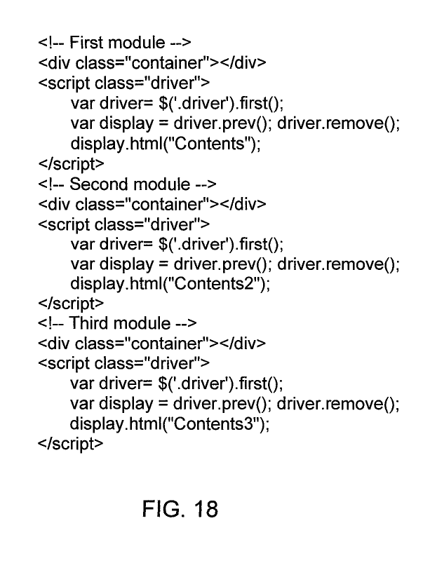

FIG. 18 illustrates the coding structure for a method of loading separate DOM modules utilizing self-referencing of running script elements. The coding structure of FIG. 18 will run sequentially, like the example of FIG. 8, but it also allows the loading of modules dynamically or asynchronously in any order, even when another script is running asynchronously elsewhere on the page. In this example, when the script runs, the JavaScript code creates a reference to itself and places the reference into the variable “driver”. Then, the display variable is set to a DOM element that can be found relative to the Driver, which allows the JavaScript to understand the context within which to manipulate the DOM. For example, the display variable may be set to a DOM element in the template immediately prior to module Driver. This sandboxes all actions by the module Driver into the referenced DOM element, thereby preventing collisions with scripts running asynchronously elsewhere on webpage and eliminating polling for matching DOM elements.

The coding structure of FIG. 18 also allows nested modules to be loaded to create parent-child relationships between modules, while maintaining the correct context for the running code within each individual module.

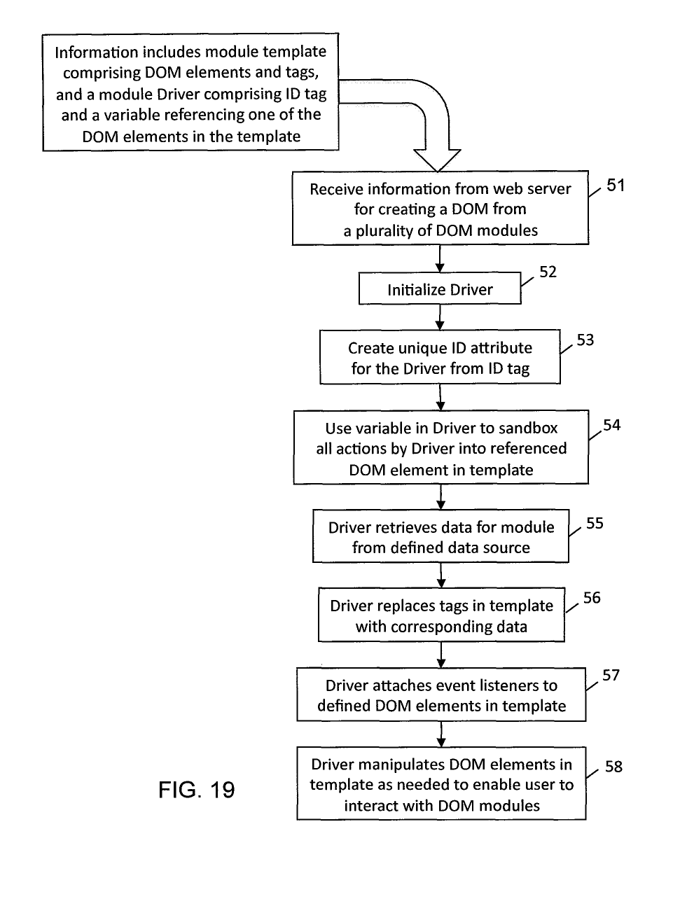

FIG. 19 is a flow chart illustrating an exemplary embodiment of a method according to the present disclosure. The method, performed in the client web browser, prevents collisions between DOM modules and eliminates polling for matching DOM elements while operating a website. The web browser is implemented in a computer and is in communication with a website server via a network connecting the computer and the web server. At step 51, the browser receives from the web server, information for creating a DOM from a plurality of DOM modules for displaying content to a user and interacting with the user. The received information includes a module template comprising DOM elements and tags to be replaced with data, and a module Driver comprising an identifier tag and a variable, which is set to reference one of the DOM elements in the template. At step 52, the Driver is initialized. At step 53, the browser creates from the Driver's identifier tag, a unique ID attribute for the Driver, thereby enabling the Driver to operate independent of other DOM modules. At step 54, the variable in the Driver is utilized to sandbox all actions by the Driver into the referenced DOM element in the template, thereby preventing collisions and eliminating polling for matching DOM elements. At step 55, the Driver retrieves data for the module from a defined data source. At step 56, the Driver replaces the tags in the template with corresponding data. At step 57, the Driver attaches event listeners to defined DOM elements in the template, and at step 58, the Driver manipulates DOM elements in the template as needed to enable user interaction with the DOM module.

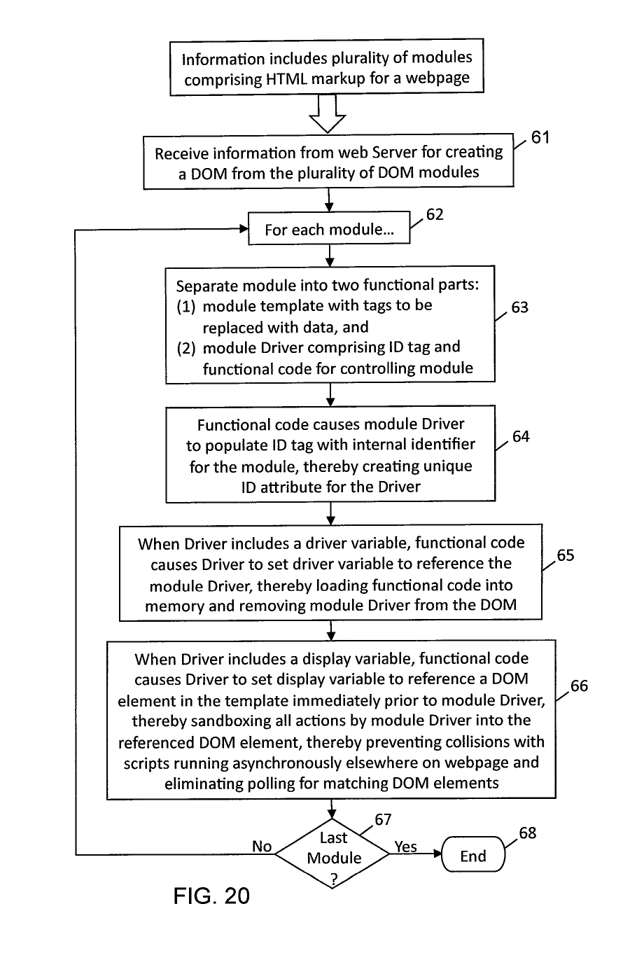

FIG. 20 is a flow chart illustrating a second exemplary embodiment of a method according to the present disclosure. This embodiment is directed toward a method of initializing and running the Driver code for each module asynchronously, rather than having one module waiting for another. This functionality improves the user experience and ensures the performance of each module does not affect the performance of other modules. Various embodiments include a method, a client web browser, and a DOM module Driver. FIG. 20 illustrates the method embodiment, which dynamically loads in any order, a plurality of modules comprising HTML markup for a webpage when one or more HTML scripts are running asynchronously elsewhere on the webpage. The browser embodiment may be performed by the browser as illustrated in FIG. 17.

At step 61, the web browser receives from the web server, information for creating a DOM from the plurality of modules. At step 62, the control processor 32 performs the following steps for each module: At step 63, the module is separated into two functional parts: (1) a module template comprising HTML markup that includes tags to be replaced with data; and (2) a module Driver comprising an identifier tag and functional code controlling the operation of the module Driver. At step 64, the functional code controlling the operation of the module Driver causes the module Driver to populate the identifier tag with an internal identifier for the module, thereby creating a unique ID attribute for the Driver. This enables the Driver to operate independent of other drivers that control other modules.

At step 65, when the module Driver includes a driver variable, the method may also include the step of setting the driver variable to reference the module Driver, thereby loading the functional code into memory and removing the module Driver from the DOM.

At step 66, when the module Driver includes a display variable, the method may also include the step of setting the display variable to reference in the module template, a DOM element immediately prior to the module Driver, thereby sandboxing all actions by the module Driver into the referenced DOM element in the template, preventing collisions with the scripts running asynchronously elsewhere on the webpage, and eliminating polling for matching DOM elements.

At step 67, the control processor 32 determines whether the last module has been processed. If not, the method returns to step 62 and repeats for each additional module until the last module has been processed. The method then ends at step 68.

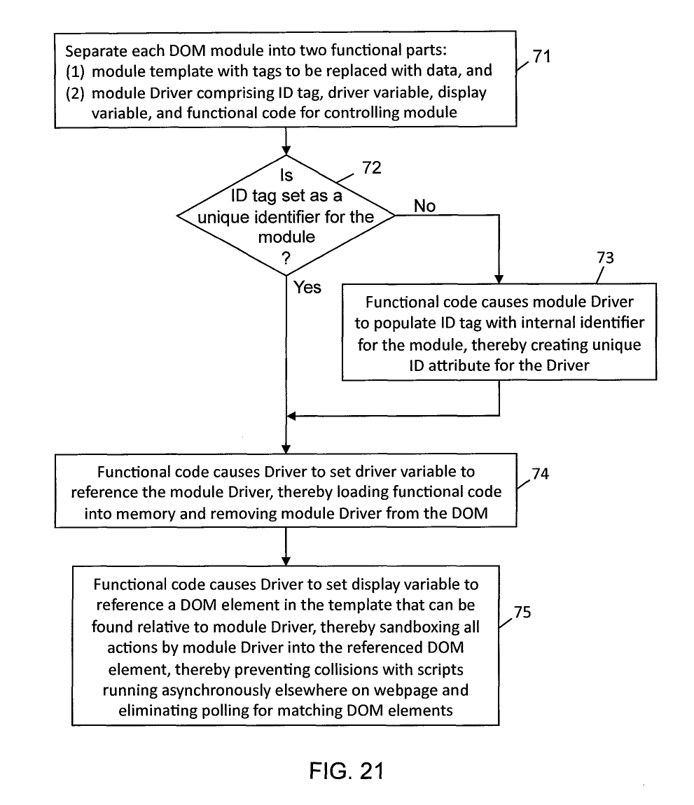

FIG. 21 is a flow chart illustrating a third exemplary embodiment of a method according to the present disclosure. The method will be described with reference to FIGS. 18 and 21. At step 71, each DOM module is separated into two functional parts: (1) a module template comprising HTML markup that includes tags to be replaced with data; and (2) a module Driver comprising an identifier tag, a driver variable, a display variable, and functional code controlling the operation of the module Driver. At step 72, it is determined whether the Driver ID tag is set as a unique identifier for the module. This value may be preset or it may be populated dynamically. If it is not preset, the method moves to step 73 where the functional code controlling the operation of the module Driver causes the module Driver to populate the identifier tag with an internal identifier for the module, thereby creating a unique ID attribute for the Driver. This enables the Driver to operate independent of other drivers that control other modules.

At step 74, the functional code causes the Driver to set the driver variable to reference the module Driver, thereby loading the functional code into memory and removing the module Driver from the DOM. At step 75, the functional code causes the Driver to set the display variable to reference in the module template, a DOM element that can be found relative to the module Driver, thereby sandboxing all actions by the module Driver into the referenced DOM element in the template. This DOM element is preferably the DOM element immediately prior to the module Driver, but it may be a different DOM element in the template as long as the element can be queried using CSS selector syntax relative to the Driver. In this case, there has to be a way to determine the specific DOM element since many of the modules will be repeated. A list of selectors may be found at the website for jQuery (api.jQuery.com) with the extensions “category/selectors/”. However, since the code is loaded in a modular fashion and the Driver is included in the module with the display or template, the simplest solution is to query the DOM element immediately prior to the module Driver.

Setting the display variable in this manner prevents collisions with the scripts running asynchronously elsewhere on the webpage, and eliminates polling for matching DOM elements.

Another embodiment of the present disclosure, made possible by the ability of the templating engine to support complex data structures, is directed toward a computer-implemented method of constructing a nested website DOM module utilizing the client-side templating engine running within the JavaScript virtual machine built into the client web browser. A processor for the client web browser, such as control processor 32 (FIG. 17) within a client computer, executes code stored in a non-transitory memory to perform the method, which includes receiving by the client-side templating engine, a single call to create the nested DOM module. The client-side templating engine then retrieves data from the data source 38. The data from the data source may include data for populating the tags in the module template and data for creating a plurality of data blocks to be included in a nested data structure. The client-side templating engine populates the tags in the module template with the data for the tags, and the module Driver sequentially creates the plurality of data blocks using the data for creating the data blocks. Upon completion of each data block, the module Driver appends the completed data block to the module template to create the nested data structure. In response to the single call to create the nested DOM module, the client-side templating engine then returns the nested DOM module including the template with populated tags and the nested data structure.

The number of data blocks appended by the DOM module Driver is not limited by the client-side templating engine. Additionally, it should be noted that additional levels of complexity can be achieved when at least one of the data blocks appended by the DOM module Driver includes multiple smaller data blocks.

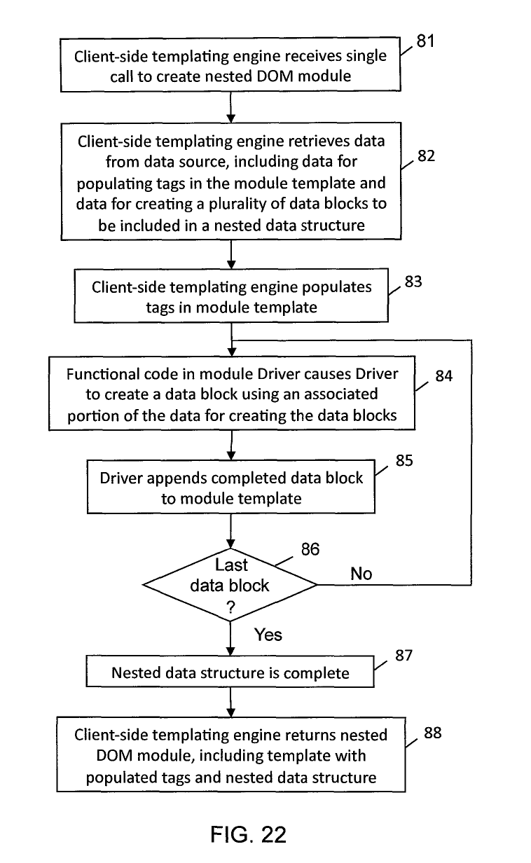

FIG. 22 is a flow chart illustrating a fourth exemplary embodiment of a method according to the present disclosure. This embodiment utilizes the client-side templating engine to construct a nested website DOM module. At step 81, the client-side templating engine receives from the web browser, a single call to create the nested DOM module. At step 82, the client-side templating engine retrieves data from the data source 38 (FIG. 17). The data from the data source may include data for populating the tags in the module template and data for creating a plurality of data blocks to be included in a nested data structure. At step 83, the client-side templating engine populates the tags in the module template with the data for the tags. At step 84, functional code in the module Driver causes the Driver to create a data block using an associated portion of the data for creating the data blocks. Upon completion of the data block, the module Driver appends the completed data block to the module template at step 85. At step 86, it is determined whether the completed data block is the last data block to be created from the retrieved data. If not, the method returns to steps 84 and 85 where the module Driver creates and appends another data block. When it is determined at step 86 that all of the data blocks have been created and appended to the module template, the method moves to step 87 and concludes that the nested data structure is complete. At step 88, the client-side templating engine then returns the nested DOM module, including the template with populated tags and the nested data structure, to the web browser.

A second important feature made possible by the ability of the templating engine to support complex data structures, is the use of embedded logic and other client-side code. For example, the module template may be constructed of a mixture of HTML markup and JavaScript code, and the data source can be used to populate fields in any portion of the template. The JavaScript code can then run complex logical calculations on the data and display different portions of the template, or display portions of the template in different ways, depending on the results of those calculations. Additionally, the JavaScript code can be used similarly to manage the DOM elements of the HTML template in order to attach event listeners to those objects, or to manipulate the objects based on user interaction or other triggering events.

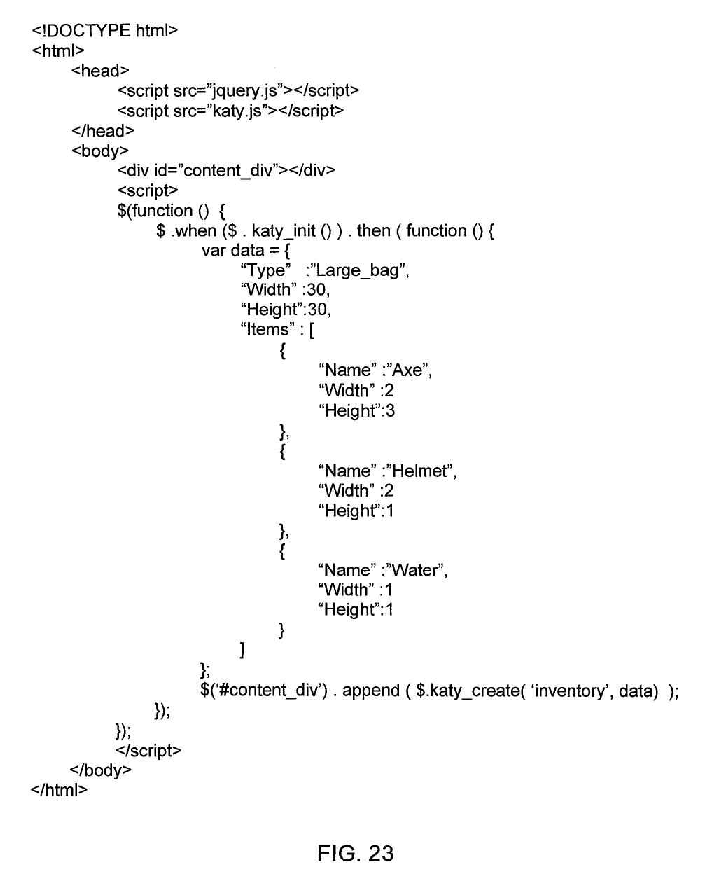

FIG. 23 illustrates the coding structure for an exemplary HTML Document, which creates a DOM instance and invokes the client side templating engine to facilitate the creation of nested templates that utilize embedded logic and client-side functional code in both a module Driver and a module template to create an inventory of items. In this example, the module creates an inventory of three items (an axe, a helmet, and water), using embedded logic for controlling the displaying of the three inventory items and the displayed sizes of the inventory items. The portion of the coding structure beginning with the ‘katy_init’ command on line 11 and running through the ‘katy_create’ command on line 34 includes functional code that creates the inventory of items and creates embedded logic for displaying the items in the sizes indicated.

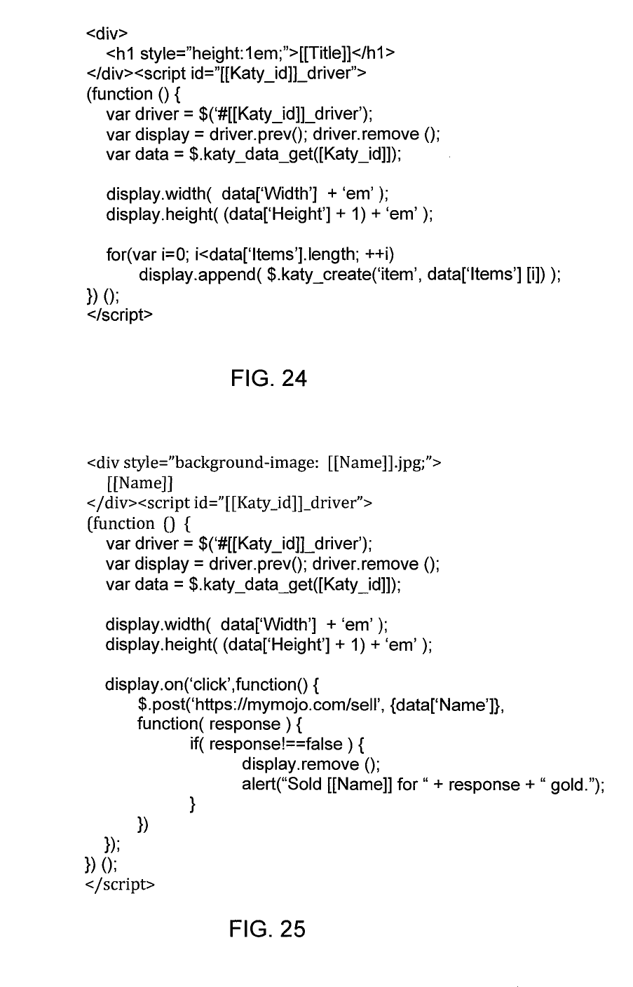

FIG. 24 illustrates a coding structure of a template referenced in FIG. 23 that is used by the katy_create function of the client side templating engine invoked in FIG. 23. The illustrated coding structure includes functional code in the module template and the HTML markup in the module template, which includes DOM elements and tags to be replaced with data. The data in this example includes the names of the three inventory items and their assigned sizes. Line 7 is an example of the process, as previously described, of populating an ID tag (Katy_id) in the module template with an internal identifier for the DOM module, thereby creating a unique ID attribute for the Driver, which enables the Driver to operate independent of other drivers that control other DOM modules. Lines 9-10 provide an example of how the module template displays different portions of the template to the user depending on the results of logical calculations performed by the functional code beginning on line 4. Lines 12-13 provide an example of how the module template displays portions of the template using different formatting depending on the results of the logical calculations.

FIG. 25 illustrates a template referenced in FIG. 24 that is used by the katy_create function of the client side templating engine invoked in FIG. 24. The three inventory items (the axe, the helmet, and the water) size themselves based on the data passed to them (lines 9-10) and an event listener is attached to listen for a user's click (line 12). Upon detecting a click, the application communicates with the server to perform a “sell” operation (line 13). If successful, the item is removed (line 16) and the user is informed of how much he earned (line 17).

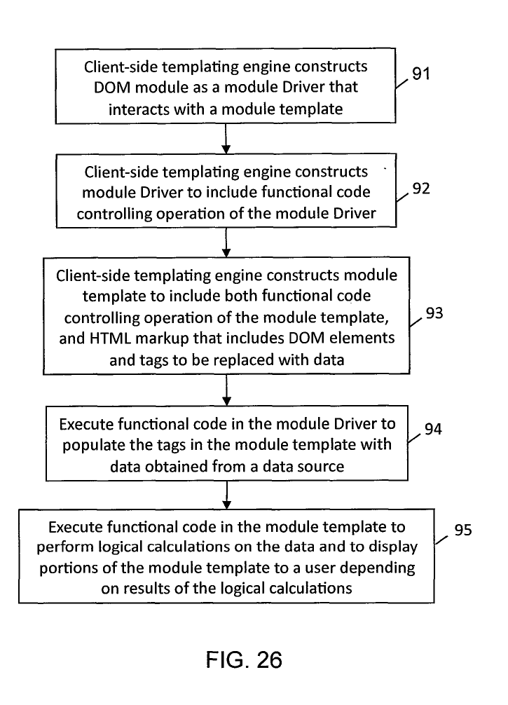

FIG. 26 is a flow chart illustrating a fifth exemplary embodiment of a method according to the present disclosure. At step 91, the client-side templating engine constructs the DOM module as a module Driver that interacts with a module template. At step 92, the client-side templating engine constructs the module Driver to include functional code controlling operation of the module Driver. At step 93, the client-side templating engine constructs the module template to include both functional code controlling operation of the module template, and HTML markup that includes DOM elements and tags to be replaced with data. At step 94, the processor running the client browser executes the functional code in the module Driver to populate the tags in the module template with data obtained from a data source. At step 95, the processor running the client browser executes the functional code in the module template to perform logical calculations on the data and to display portions of the module template to a user depending on results of the logical calculations.

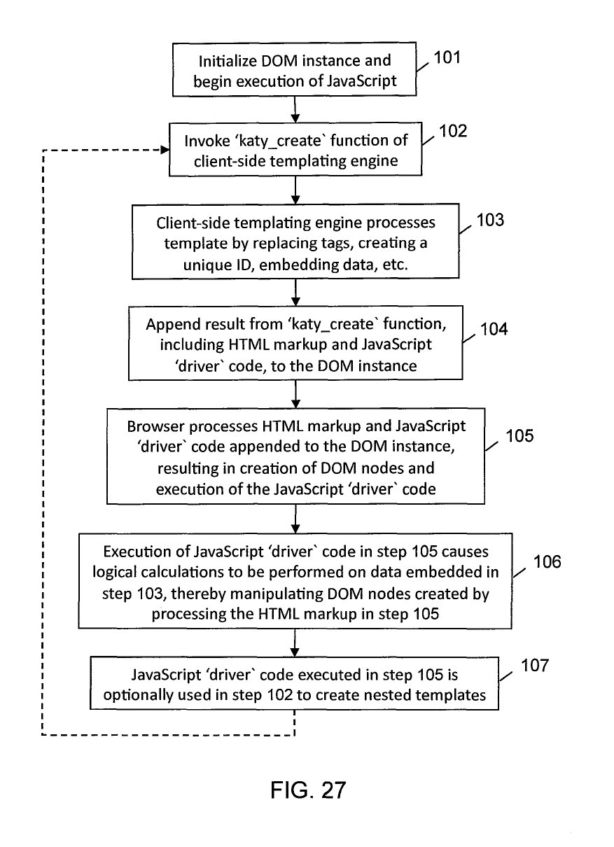

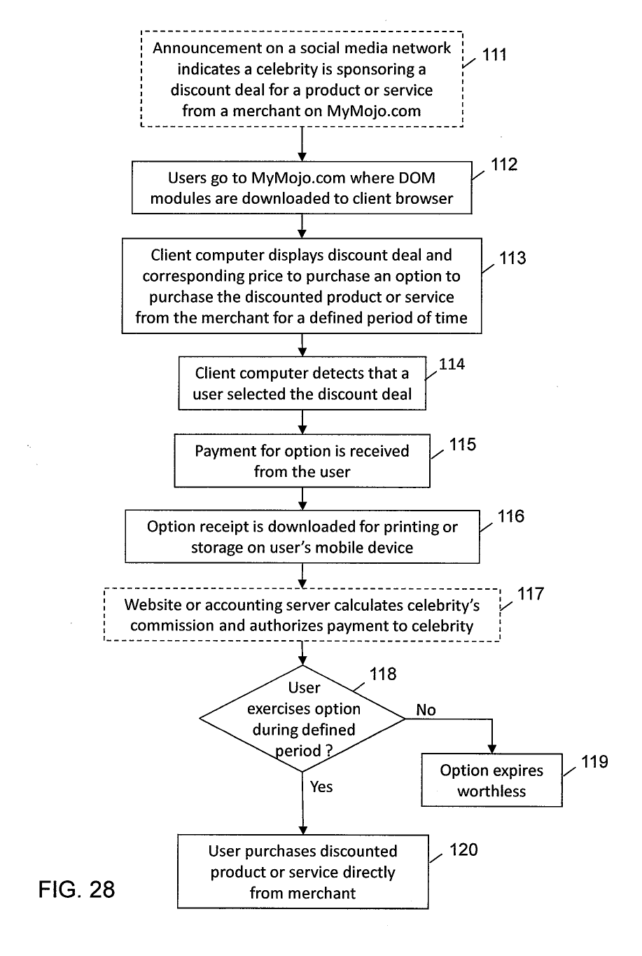

FIG. 27 is a flow chart illustrating additional details of the module execution of FIG. 26, as performed by the client-side browser processor. At step 101, the browser initializes the DOM instance and begins execution of the JavaScript functional code. At step 102, the browser invokes the katy_create function of the client-side templating engine. At step 103, the browser causes the client-side templating engine to process the module template by replacing tags, creating a unique ID, embedding data, and so on. At step 104, the templating engine appends the result from the ‘katy_create’ function, including HTML markup and JavaScript ‘driver’ code, to the DOM instance. At step 105, the browser processes the HTML markup and JavaScript ‘driver’ code appended to the DOM instance. This results in the creation of DOM nodes and execution of the JavaScript ‘driver’ code. At step 106, execution of the JavaScript ‘driver’ code causes logical calculations to be performed on the data embedded in step 103, thereby manipulating DOM nodes created by processing the HTML markup in step 105. At step 107, the method optionally returns to step 102 where the JavaScript ‘driver’ code executed in step 105 is used to create nested templates, as described above.

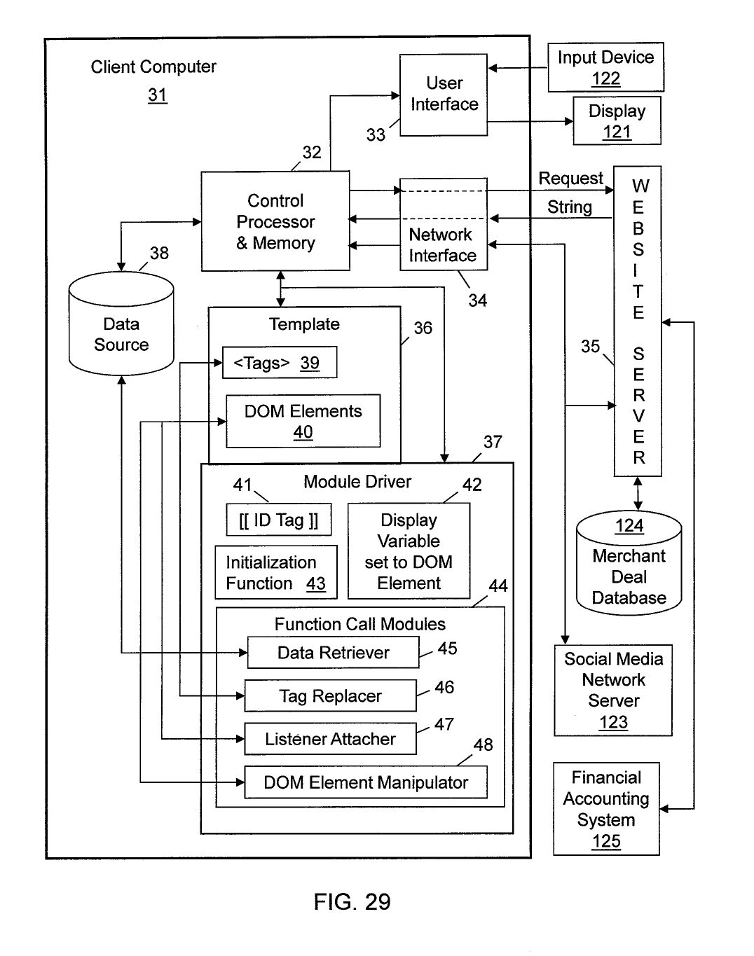

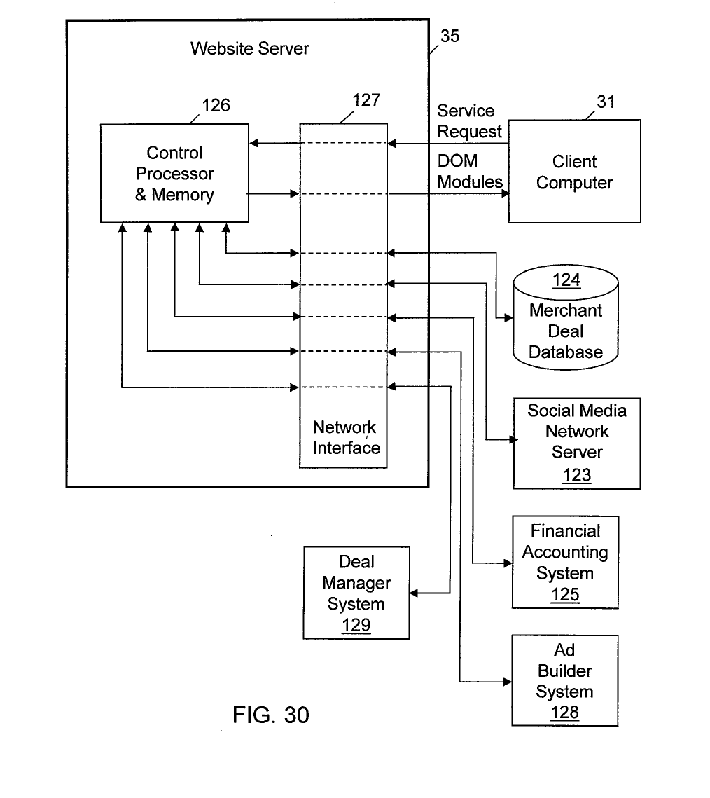

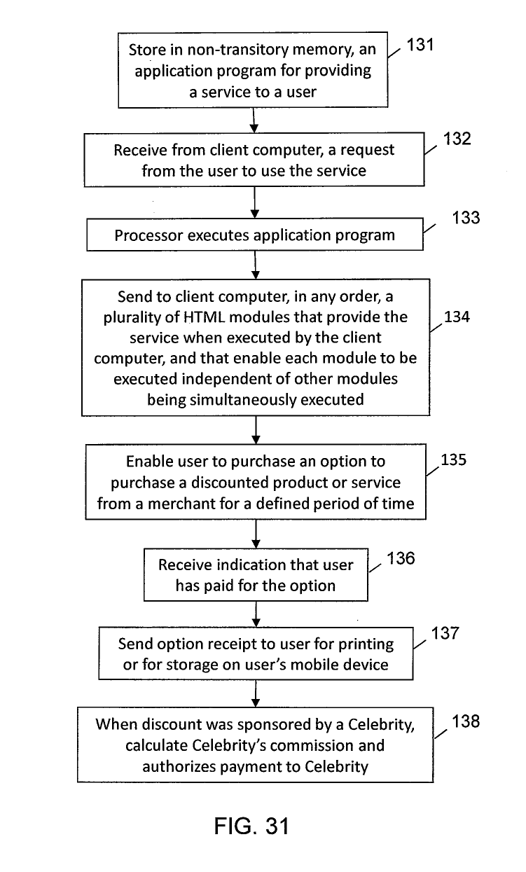

FIG. 28 is a flow chart illustrating a sixth exemplary embodiment of a method according to the present disclosure. The illustrated method provides a service to a user. In particular, in this embodiment, a client computer 31, for example desktop, laptop, tablet, smartphone, or other network-enabled computing device, (see FIG. 29) interacts with a remote website server 35 (see FIG. 30) to enable the user to purchase an option to purchase a discounted product or service from a merchant for a defined period of time. The option provides the user the right, but not the obligation, to purchase the discounted product or service. The price of the option, which is similar to a premium paid for a stock option on the stock market, is a relatively small amount in comparison to the value of the discount savings. For example, the user may pay $0.99 for the option to purchase an $80 product for $40 when the purchase is made within a week. If the user fails to exercise the option during the defined time period, the option may expire worthless and the relatively small price paid for the option is forfeited.

At step 111, an optional step is shown illustrating a way to generate increased interest in the discount deal and drive a greater number of users to the website where the option may be purchased. In this example, an announcement is made on a social media network indicating that a celebrity is promoting a discount deal for a product or service from a merchant on a website such as mymojo.com. The celebrity may have millions of “followers” on the social media network, and at step 112, some percentage of those followers will see the announcement and navigate their client computer to the website where DOM modules are downloaded to their browsers as described above. At step 113, a particular user's client computer displays the promoted discount deal together with the corresponding price to purchase the option to purchase the discounted product or service from the merchant for the defined period of time. At step 114, the client computer 31 detects that the user selected to purchase the option for the discount deal. At step 115, payment for the option is received. This may be done in a number of ways. For example, users may pay on their mobile device directly through their carrier; by registering credit card information with mymojo.com or within the mymojo app that may be downloaded to their mobile device; by pre-purchasing a number of option credits from mymojo.com, or by other suitable payment methods.

At step 116, a receipt for the option is downloaded to the client computer 31 for printing or for storage on the user's mobile device. The user can use the printed or stored receipt to exercise the option directly with the merchant. Step 117 is another optional step, which is related to the use of a celebrity to drive users to the website. In this step, the website server 35 or a server in a financial accounting system 125 (see FIG. 29) may calculate a commission for the celebrity in accordance with an agreement between the celebrity and mymojo.com, and may authorize payment of the commission to the celebrity. At step 118, it is determined whether the user exercises the option during the defined period of time. If not, as noted above, the option may expire worthless at step 119, and the user forfeits the relatively small price paid for the option. When the user exercises the option at step 120, the user purchases the discounted product or service directly from the merchant without any further involvement by mymojo.com. The merchant does not pay any commission to mymojo.com and collects the entire discounted price of the product or service.

FIG. 29 is a simplified block diagram of an apparatus in a client computer 31 for providing a service to a user in accordance with the present disclosure. An execution unit 32 including a processor coupled to a memory executes a client application program to perform the method of FIG. 28. When performing selected steps of the method of FIG. 28, the apparatus interacts with the website server 35 through the network interface 34 to obtain the DOM modules for loading the website. The user interface 33 enables communication to and from the user, and may communicate between the apparatus and a data output device such as a visual display 121, audio output speaker, or other suitable output device for presenting the promoted discount deal to the user together with the corresponding price to purchase the option to purchase the discounted product or service from the merchant for the defined period of time. The user interface may also communicate with a data input device 122 such as a keyboard, mouse, touch-screen display, voice recognition program, or other suitable input device to detect that the user selected to purchase the option for the discount deal, and to receive payment for the option from the user.

FIG. 29 also illustrates that the client computer 31 may interface with a social media network server 123 when the user has navigated to the social media network for observation of the optional celebrity announcement regarding the discount deal. Additionally, the website server 35 is shown to interface with a merchant deal database 124 to retrieve and send the discount deal to the client computer 31 when the user navigates to the website. Although shown as an external database, the merchant deal database may be located internally or externally to the website server. The merchant deal database may be updated periodically or as required with new deals available to the user. For example, a new “daily deal” promoted by a different celebrity may be loaded each day. Deals may offer options to users on a local, regional, national, or even international scale. For example, a locally owned restaurant may offer a deal that the website server only shows to users located within a defined geographic region near the restaurant. Alternatively, chain stores with locations across the country may offer deals that the website server shows to users anywhere in the country. The website server may also interface with a financial accounting system 125 for recording user payments for options and/or for the optional payment of the celebrity's commission.

FIG. 30 is a simplified block diagram of the website server 35 configured to provide the service to the user in accordance with the present disclosure. An execution unit 126 including a processor coupled to a memory executes an application server program to interact with the client browser 31 while the browser performs the method of FIG. 28. The website server interacts with the client browser through a network interface 127 to send the DOM modules to the client browser for loading the website and to obtain information from the client browser such as the user's location, the user's selection of options to purchase, and payment information.

The website server 35 may also interface with the social media network server 123 to provide deal information on the social media network and/or to provide a link on the social media network to direct users to the website when the users select the link. The website server 35 also interfaces with the merchant deal database 124 to retrieve and send discount deals to the client computer 31 when the user navigates to the website. The website server may also interface with the financial accounting system 125 for recording user payments for options and/or for the optional payment of the celebrity's commission.

The website server 35 may also interface with an internal or external advertisement builder (adbuilder) system 128. The adbuilder system is accessible by merchants and provides merchants with the capability to quickly and easily design and create their own offers for options, coupons, classified ads, auctions, and the like, and post the offers on the website. The adbuilder system includes a database of customizable templates, which, by responding to queries and prompts, can be filled with text and photographs. The photographs may be selected from an extensive library of photographs stored in the system, or the merchant can upload its own photographs. The system presents a preview of the ad to the merchant as the ad is being built and enables a final review and approval prior to posting the ad on the website.

To further automate interactions with merchants, the website server 35 may also interface with a deal manager system 129. The deal manager system provides the merchants with information and interactive capabilities to enhance efficient management of their accounts and businesses. For example, the deal manager system may interact with a merchant to perform such functions as: (1) track sales of the merchant's options; (2) download the merchant's coupons whenever desired; (3) view a list of the merchant's options and coupons previously created and the status of each; (4) mark individual deals as redeemed; (5) renew a currently running deal; (6) clone a previous option or coupon in order to run it again without having to re-enter information; and (7) other related management functions for efficient management of the merchant's account and business.

FIG. 31 is a flow chart illustrating a seventh exemplary embodiment of a method according to the present disclosure. This embodiment describes a method performed by an application server such as the website server 35. At step 131, the server stores in a non-transitory memory, an application program for providing a service to a user. At step 132, the server receives from the client computer, a request from the user to use the service. For example, the website server may receive a request for the user to download the DOM modules for a website such as mymojo.com. In response, the processor 131 executes the application program at step 133.

At step 134, the server 35 sends to the client computer 31, in any order, a plurality of HTML modules that provide the service when executed by the processor 32 of the client computer. The modules are designed so that each module can be executed independent of other modules that are being simultaneously executed. At step 135, the server enables the user to purchase an option to purchase a discounted product or service for a defined period of time. At step 136, the server receives an indication that the user has paid for the option. At step 137, the server sends an option receipt to the user for printing or storage on the user's mobile device. The user can then go directly to the merchant with the option receipt to purchase the discounted product or service. This purchase may be made without further involvement by the website server and without any commission payable by the merchant. When the discount was promoted by a celebrity, the server may calculate the celebrity's commission and authorize payment to the celebrity at step 138.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An apparatus in a client computer that interacts with a user and with a remote application server to provide a service to the user, the apparatus comprising:
a non-transitory memory that stores a client application program;
an execution unit comprising a processor coupled to the memory, the processor executing the client application program; and
a communication interface that communicates between the client computer and the remote application server via a network, the communication interface receiving from the remote application server, in any order, a plurality of modules comprising Hypertext Markup Language (HTML) markup code and functional code;
wherein the execution unit separates each module into two functional parts during execution, the functional parts including:
a module template comprising elements of HTML markup code that include tags to be replaced with data; and
a module Driver comprising an identifier (ID) tag and functional code controlling the operation of the module Driver;
wherein when the processor executes the functional code controlling the operation of the module Driver, the module Driver is caused to attach event listeners to the elements in the module template, and to populate the ID tag with an internal identifier for the module, thereby creating a unique ID attribute for the Driver, which enables the Driver to operate independent of other drivers that control other modules executing simultaneously on the client computer.

2. The apparatus as recited in claim 1, further comprising:
a display interface that presents on a display, at least one block of graphics or descriptive text, wherein the at least one block is associated with a link for selective activation by a user;
wherein the execution unit is coupled to the display interface and is further configured to:
execute the functional code in the module Driver to populate the tags in the module template with data obtained from a data source;
execute the functional code in the module template to perform logical calculations on the data, and to display portions of the module template on the display depending on results of the logical calculations; and
execute the functional code in the module Driver to detect activation of the link by the user as a triggering event, and to manipulate the elements in the module template based on the triggering event.

3. The apparatus as recited in claim 2, wherein the Driver also includes a variable, which is set to reference an element in the template, thereby sandboxing all actions by the Driver into the referenced element in the template, preventing collisions, and eliminating polling for matching elements.

4. The apparatus as recited in claim 3, wherein the application program is a client web browser, the remote application server is a website server, and the modules are Document Object Model (DOM) modules for operating a webpage.

5. The apparatus as recited in claim 4, wherein execution of the DOM modules causes the display interface to display in the at least one block of graphics or descriptive text, a description of a discounted product or service from a merchant; causes the module Driver to detect activation of an associated link by the user; and in response, causes the communication interface to send an indication to the website server that the user desires to purchase an option to purchase the product or service from the merchant at a discounted price for a defined period of time.

6. The apparatus as recited in claim 4, wherein the user is initially logged onto a social media network, and the web browser first displays to the user, an announcement on the social media network indicating that a discount is available on the website for a product or service from a merchant;
wherein, when the user indicates a desire to navigate to the website, the web browser requests to connect to the website server;
wherein the website server executes a server application program enabling the user to purchase an option to purchase the product or service from the merchant at a discounted price for a defined period of time.

7. The apparatus as recited in claim 6, wherein, when displaying the announcement on the social media network, the web browser indicates that the discount for the product or service is promoted by a celebrity.

8. An application server that interacts with a remote client computer to provide a service to a user, the application server comprising:
a non-transitory memory that stores an application program;
an execution unit comprising a processor coupled to the memory, the processor executing the application program; and
a communication interface that communicates between the application server and the remote client computer via a network, the communication interface receiving from the client computer, a request from the user to use the service, and in response, the application server sending to the remote client computer, in any order, a plurality of modules comprising Hypertext Markup Language (HTML) markup code and functional code that, when executed by the client computer, provides the service to the user and enables each module to be executed independent of others of the plurality of modules that are executing simultaneously on the client computer.

9. The application server as recited in claim 8, wherein the application server is a website server, the client computer executes a client web browser, and the modules are Document Object Model (DOM) modules for operating a webpage.

10. The application server as recited in claim 9, wherein the website server executes the application program to enable the user to purchase an option to purchase a product or service from a merchant at a discounted price for a defined period of time.

11. The application server as recited in claim 10, wherein the communication interface also connects the application server to a social media network, wherein an announcement on the social media network indicates that a discount is available for the product or service from the merchant, wherein when the client computer requests to connect to the website server, the website server is caused to send the DOM modules to the client computer, thereby displaying the website to the user and enabling the user to purchase the option to purchase the product or service from the merchant at the discounted price for the defined period of time.

12. The application server as recited in claim 11, wherein the announcement on the social media network indicates that the discount for the product or service is endorsed by a celebrity, and when the user purchases the option, the application server sends an indication of the purchase to a financial accounting system where a credit is applied to an account of the celebrity.

13. The application server as recited in claim 10, wherein when the user purchases the option, the website server provides information to the user enabling the user to exercise the option to purchase the product or service directly from the merchant without further involvement by the website server and without any commission payable by the merchant.

14. The application server as recited in claim 13, wherein the communication interface also provides the merchant with access to an advertising application program that provides the merchant with online tools to design and create for display on the website, an advertisement for the discounted product or service.

15. A computer-implemented method in an application server for providing a service to a user, wherein the application server interacts with a remote client computer via a network to provide the service to the user, the method comprising the steps of:
storing in a non-transitory memory coupled to a processor, an application program for providing the service to the user;
receiving via a communication interface from the remote client computer, a request from the user to use the service; and
in response to receiving the request, executing the application program by the processor, wherein executing the application program includes:
sending to the remote client computer, in any order, a plurality of modules comprising Hypertext Markup Language (HTML) markup code and functional code that, when executed by the client computer, provides the service to the user and enables each module to be executed independent of others of the plurality of modules that are executing simultaneously.

16. The method as recited in claim 15, wherein the application server is a website server and the remote client computer executes a client web browser, and the step of sending the plurality of modules to the remote client computer includes sending to the remote client computer, in any order, a plurality of Document Object Model (DOM) modules for operating a webpage.

17. The method as recited in claim 16, wherein the website server executes the application program to enable the user to purchase an option to purchase a product or service from a merchant at a discounted price for a defined period of time.

18. The method as recited in claim 17, further comprising:
connecting the website server to a social media network;
displaying an announcement on the social media network indicating that a discount for the product or service from the merchant is available on the website;
when the remote client computer requests to connect to the website server, sending the DOM modules from the website server to the remote client computer; and
receiving an indication from the remote client computer that the user selected to purchase the option to purchase the product or service from the merchant at the discounted price for the defined period of time.

19. The method as recited in claim 18, wherein the announcement on the social media network indicates that the discount for the product or service is promoted by a celebrity, and the method further comprises, after receiving the indication from the remote client computer that the user selected to purchase the option, sending an indication of the purchase from the application server to a financial accounting system where a credit is applied to an account of the celebrity.

20. The method as recited in claim 17, further comprising:
receiving an indication from the remote client computer that the user selected to purchase the option to purchase the product or service from the merchant at the discounted price for the defined period of time; and
providing information to the user enabling the user to exercise the option to purchase the product or service directly from the merchant without further involvement by the website server and without any commission payable by the merchant.

21. The method as recited in claim 20, further comprising:
providing the merchant with access to an advertisement building program; and
executing the advertisement building program by the processor, wherein executing the advertisement building program includes providing the merchant with online tools to design and create for display on the website, an advertisement for the discounted product or service.

22. The method as recited in claim 20, further comprising:
providing the merchant with access to a deal management program; and
executing the deal management program by the processor, wherein executing the deal management program includes providing the merchant with information and interactive capabilities to manage and track the effectiveness of options posted on the website.
